(19) United States
(12) Patent Application Publication
(10) Pub. No.: US 2015/0195626 A1
(43) Pub. Date: Jul. 9, 2015

(54) AUGMENTED MEDIA SERVICE PROVIDING METHOD, APPARATUS THEREOF, AND SYSTEM THEREOF

(71) Applicant: Electronics and Telecommunications Research Institute, Daejeon (KR)

(72) Inventors: Moon-Soo LEE, Daejeon (KR); Min-Jung KIM, Daejeon (KR); Seung-Joon KWON, Seoul (KR); Kee-Seong CHO, Daejeon (KR)

(21) Appl. No.: 14/318,811

(22) Filed: Jun. 30, 2014

(30) Foreign Application Priority Data
Jan. 9, 2014 (KR) 10-2014-0002993

(51) Int. Cl. H04N 21/81; H04N 21/2668; H04N 21/24; H04N 21/2383; H04N 21/237; H04N 21/61; G06F 17/30; H04N 21/234

(52) U.S. Cl. CPC H04N 21/8133; G06F 17/30017; H04N 21/2668; H04N 21/23418; H04N 21/2383; H04N 21/237; H04N 21/6125; H04N 21/2407

(57) ABSTRACT

The present invention relates to a method, apparatus and system for providing augmented media service. An augmented media service providing apparatus according to an embodiment of the present invention comprises an image retrieval part receiving capture images generated by taking the screen of media contents being displayed on a broadcasting/media receiving terminal from a user device, and identifying a targeted media content based on pre-established signature information database for scene recognition and the capture images; and an additional content providing part selecting at least one additional content information which is used for augmenting the targeted media content from pre-stored additional content information based on identification information of the targeted media content and transmitting the selected additional content information and signature information of the targeted media content to the user device. According to embodiments of the present invention, augmented media services are provided without any modification of media contents.

### CROSS REFERENCE TO RELATED APPLICATION

This application claims the benefit of Korean Patent Application No. 10-2004-0002993, filed on Jan. 9, 2014, entitled “Augmented media service providing method and apparatus thereof and system thereof”, which is hereby incorporated by reference in its entirety into this application.

### BACKGROUND OF THE INVENTION

1. Technology Field

The present invention relates to a method, apparatus and system for providing augmented media service.

2. Description of the Related Art

Augmentation technique in the media field is a technique capable of overlaying additional information of captions or corresponding scenes on an existing image through computer graphics. Such a technique can provide a variety of information which cannot be expressed in an original image. Augmentation technique has created added values in various fields of media-based entertainments, advertisements and educations.

In general, a method for combining additional information at the beginning or ending part of media or a method for pre-selecting a point where information will be expressed during video editing by using metadata is used to add additional information to video media. The former is usually used for web-based media contents (for example, You Tube contents) or video on demand (VOD) services. The latter is usually used for broadcasting media such as TV and requires a separate real time processing module to generate or interpret metadata-based augmented information.

Consumptions for multimedia such as high quality music and images have constantly increased due to expanded markets of mobile devices or televisions. However, there are limits for providers of communications and IPTVs (internet protocol TV) to make profits by providing VOD-type media so that they like to make profits by providing media associated with advertisements or bidirectional services. Typical services for this purpose may be augmented broadcasting or second screen services.

Augmented broadcasting has an advantage for users of receiving real time high quality bidirectional services through TV with only metadata decoding. However, since TV consumes media at a constant distance, it may not easy to consume interactive bidirectional contents. In addition, since a plurality of augmented information exists in a scene, it disrupts immersiveness to media. Since augmented information should be generated while generating media, media should be produced from the beginning when any change of the augmented information is needed later.

A second screen service allows the practice of using mobile terminals such as cellphones or tablets which interact with augmented broadcasting-related bidirectional contents instead consuming on TV. The second screen service allows executing various interactive contents by using mobile terminals but since media and bidirectional contents cannot be seen at the same time, watching programs may be distracted.

Unlike an augmented broadcasting service using a conventional metadata method, a second screen solution using recently introduced server-based audio and video recognition minimizes correlations between augmented interactive contents and metadata but when a user changes a media reproduction position, there is a limit to continuously display real time augmented information on a mobile terminal.

### SUMMARY OF THE INVENTION

Exemplary embodiments of the present invention provide an augmented media service method which facilitates updates of additional contents.

Exemplary embodiments of the present invention further provide a method for displaying simultaneously media contents and additional contents in real time.

An augmented media service providing apparatus according to an embodiment of the present invention comprises an image retrieval part receiving capture images generated by taking the screen of media contents being displayed on a broadcasting/media receiving terminal from a user device, and identifying a targeted media content based on pre-established signature information database for scene recognition and the capture images; and an additional content providing part selecting at least one additional content information which is used for augmenting the targeted media content from pre-stored additional content information based on identification information of the targeted media content and transmitting the selected additional content information and signature information of the targeted media content to the user device.

An augmented media service providing method according to an embodiment of the present invention comprises receiving capture images generated by taking the screen of media contents being displayed on a broadcasting/media receiving terminal from a user device; identifying a targeted media content based on pre-established signature information database for scene recognition and the capture images; selecting at least one additional content information which is used for augmenting the targeted media content from pre-stored additional content information based on identification information of the targeted media content; and transmitting the selected additional content information and signature information of the targeted media content to the user device.

An augmented media service providing system according to an embodiment of the present invention comprises a user device generating capture images by taking the screen of media contents being displayed on a broadcasting/media receiving terminal, transmitting the capture images to an augmented media service platform when the targeted media content is not identified, and displaying additional contents based on the information received from the augmented media service platform; and the augmented media service platform identifying the targeted media content based on pre-established signature information database for scene recognition and the capture images, selecting at least one additional content information, which is used to augment the targeted media content, from pre-stored additional content information based on identification information of the targeted media content, and transmitting the selected additional content information and the signature information of the targeted media content to the user device.

According to exemplary embodiments of the present invention, it is able to provide real time augmented media services by easily adding or updating additional information of media contents without any modification of media contents.

### BRIEF DESCRIPTION OF THE DRAWINGS

FIG. 1 illustrates an augmented media service providing method according to an embodiment of the present invention.

FIG. 2 is a flowchart illustrating an augmented media service providing method according to an embodiment of the present invention.

FIG. 3 is a flowchart illustrating an augmented media service providing method according to another embodiment of the present invention.

FIG. 4A and FIG. 4B illustrate additional content information according to an embodiment of the present invention.

FIG. 5 illustrates signature information according to an embodiment of the present invention.

FIG. 6 is a block diagram illustrating an augmented media service providing apparatus according to an embodiment of the present invention.

FIG. 7 is a flowchart illustrating an augmented media service providing method from a user device according to an embodiment of the present invention.

FIG. 8 is a block diagram illustrating an augmented media service providing apparatus from a user device according to an embodiment of the present invention.

FIG. 9 illustrates an augmented media service providing screen according to an embodiment of the present invention.

### DESCRIPTION OF THE EXEMPLARY EMBODIMENTS

Throughout the description of the present invention, when describing a certain technology is determined to evade the point of the present invention, the pertinent detailed description will be omitted.

Hereinafter, exemplary embodiments of the present invention will be described in detail with reference to the accompanying drawings.

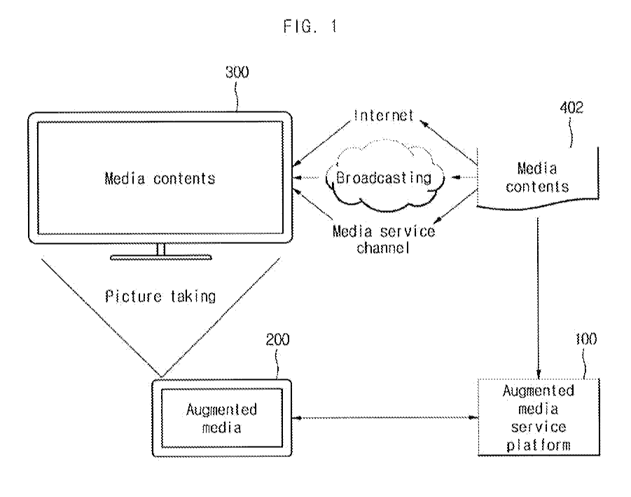

An augmented media service providing method according to an embodiment of the present invention will be described with reference to FIG. 1.

FIG. 1 illustrates an augmented media service providing method according to an embodiment of the present invention.

A broadcasting/media receiving terminal 300 receives media contents 402 through terrestrial channels or various networks and displays the received media contents 402. The broadcasting/media receiving terminal 300 may be a terminal comprising a screen such as TVs, monitors and projects, etc. The media contents 402 may include internet contents (such as Youtube). IPTV contents and various VOD contents.

A user device 200 takes a screen of the media content 402 being displayed on the broadcasting/media receiving terminal 300 and generates and displays capture images of the taken images. The user device 200 transmits the generated capture image to the augmented media service platform 100. The user device 200 may be a device equipped with a variety of photographing means such as a camera or may be one of a cell phone, a smart phone, a navigation, a personal digital assistant (PDA), a portable multimedia player (PMP), a tablet, a netbook, a desktop computer, a notebook computer, a head mounted display (HMD), a head-up display (HUD), and a communication terminal capable of accessing internet. The taken image (or photographing image) may be a preview image of a preview mode.

The augmented media service platform 100 identifies the media content 402 including the corresponding capture image, which is the media content 402 being displayed on the broadcasting/media receiving terminal 300, based on the capture image received from the user device 200 and the pre-established database, obtains information which is used to augment the corresponding media content 402, and transmits the result to the user device 200.

The user device 200 displays the augmented media on the basis of the Information received from the augmented media service platform 100. For example, the user device 200 may display additional contents along with preview images of the screen being displayed on the broadcasting/media receiving terminal 300. The additional contents may be bidirectional contents. For example, the additional contents may be provided in the form of uniform resource locator (URL) and the contents indicated by the corresponding URL may be displayed if there is a user's selection.

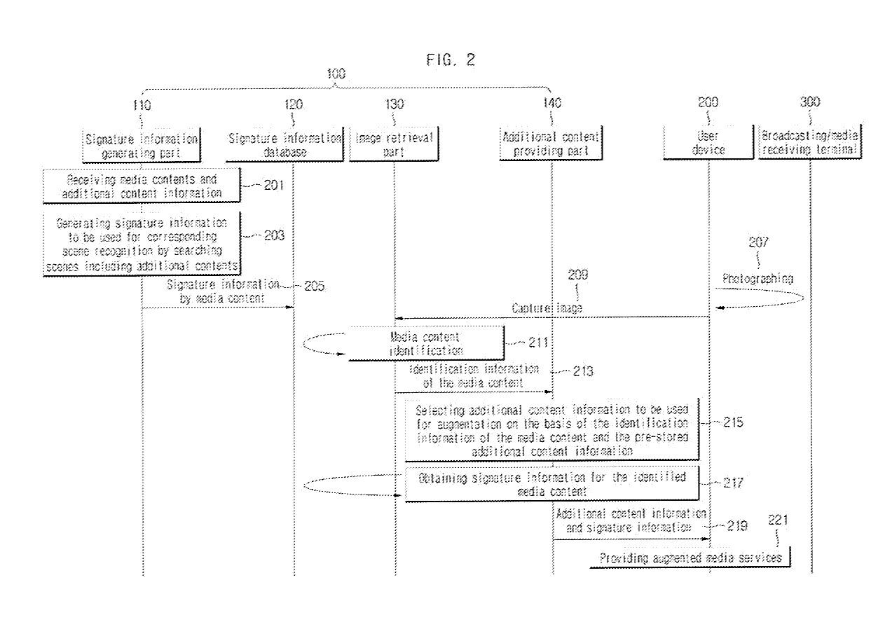

FIG. 2 is a flowchart illustrating an augmented media service providing method according to an embodiment of the present invention.

In an embodiment of the present invention, the augmented media service platform 100 may comprise a signature information generating part 110, a signature information database 120, an image retrieval part 130 and an additional content providing part 140. At least one of those components may be omitted.

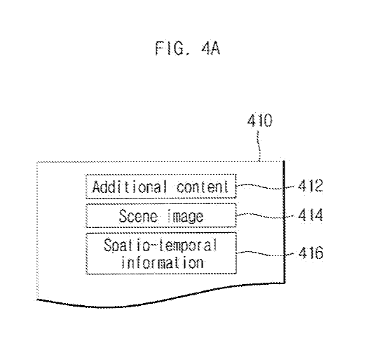

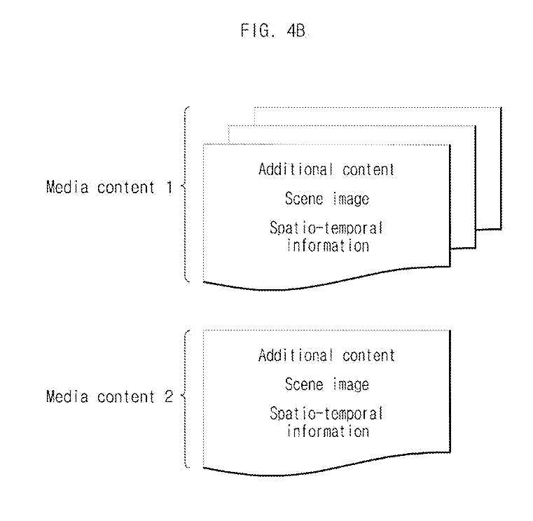

In 201, the signature information generating part 110 receives media contents and additional content information which is used for augmenting the corresponding media content. The additional content information may comprise at least one selected from additional contents to be augmented to the media content, at least one scene image relating to the additional contents, and spatio-temporal information for displaying the additional contents in the user device. It will be described in detail with reference to FIG. 4A and FIG. 4B.

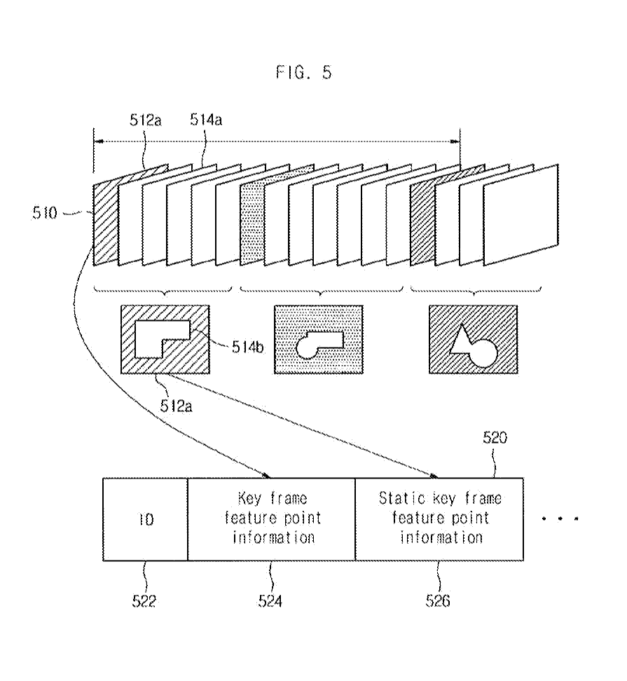

In 203, the signature information generating part 110 compares feature points of each frame for the media content included in the augmented media service platform 100 with feature points of the corresponding scene image and when scenes in which additional contents will be included is searched (for example, if it is a thing, it can be a scene including corresponding object), generates signature information to be used for recognition of the corresponding scene. The signature information may comprise identification information of the corresponding additional content (for example, ID) and feature point information for frames of which the corresponding additional content will be augmented. The signature information is used for image recognition by the user device. It will be described in detail with reference to FIG. 5.

In 205, the signature information generating part 110 stores the generated signature information to the signature information database 120. The signature information generating part 110 according to an embodiment may store the signature information by the identified media content.

In 207, the user device 200 photographs the screen being displayed on the broadcasting/media receiving terminal 300.

In 209, the user device 200 generates capture images for the photographing images and transmits the generated capture images to the image retrieval part 130. The photographing images may be preview images of a preview mode. The capture image according to an embodiment may be a capture image of pure image display in which surrounding areas are eliminated through screen-area recognition of the broadcasting/media receiving terminal 300.

In 211, the image retrieval part 130 identifies the targeted media content based on the received capture image and the signature information stored in the signature information database 120. Identifying the media content is obtaining identification information such as ID of the corresponding media content.

In 213, the image retrieval part 130 transmits identification information of the corresponding media content to the additional content providing part 140.

In 215, the additional content providing part 140 selects an additional content information which is used for augmenting the corresponding media content on the basis of the identification information of the media content received from the image retrieval part 130 and the pre-stored additional content information. For example, the additional content information may be stored by media content and the additional content providing part 140 may select additional content information stored by corresponding to the identification information of the received media contents.

In 217, the additional content providing part 140 obtains signature information for the identified media content from the signature information database 120. For example, the signature information may be stored by media content and the additional content providing part 140 may select signature information stored by corresponding to the identification information of the received media contents.

In 219, the additional content providing part 140 transmits the selected additional content information and the obtained signature information to the user device.

In 221, the user device 200 provides augmented media services on the basis of the information received from the additional content providing part 140. For example, the user device 200, when any scene is recognized to match with the signature information during previewing the screen being displayed on the broadcasting/media receiving terminal 300, selects additional content information relating the corresponding scene and displays additional contents according to the selected additional content information.

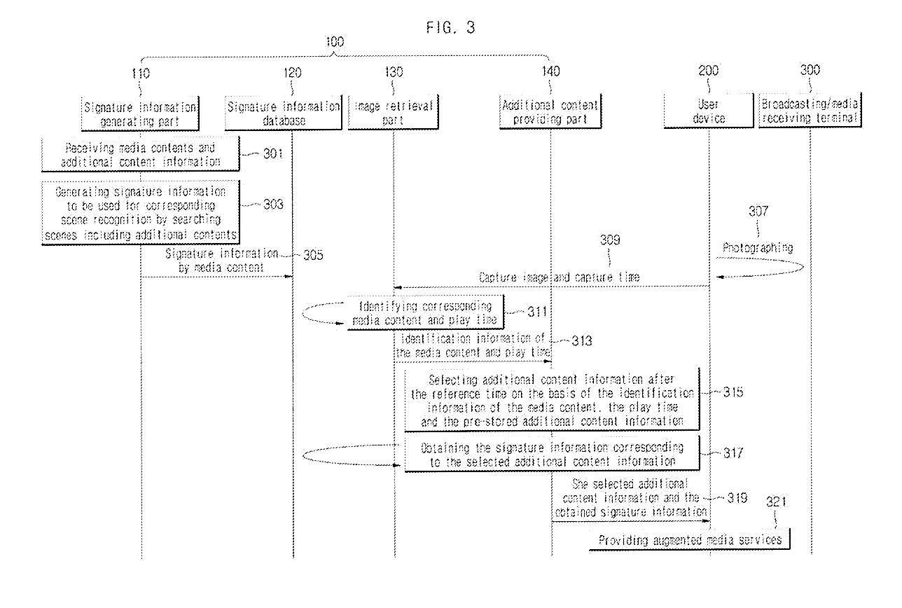

The augmented media service platform according to an embodiment of the present invention of FIG. 2 transmits all additional content information relating to the media content being displayed on the broadcasting/media receiving terminal to the user device. According to an embodiment, in case of particularly real-time broadcasting/streaming contents, identifying play time of the media content currently being displayed and transmitting only additional content information which is displayed after the corresponding play time to the user device is able to reduce network loads and search operations and thus improve performance. It will be described in more detail with reference to FIG. 3.

FIG. 3 is a flowchart illustrating an augmented media service providing method according to another embodiment of the present invention.

Since steps from 301 to 307 are identical to those of 201 to 207 of FIG. 2, the detail explanation will be omitted.

In 309, the user device 200 provides a capture image and capture time for generating the corresponding capture image to the image retrieval part 130.

In 311, the image retrieval part 130 identifies corresponding media content on the basis of the capture image received from the user device 200 and the signature information stored in the signature information database 120. The image retrieval part 130 also identifies play time of the corresponding media content. For this purpose, the signature information generating part 110, when signature information is generated, may store the play time for the corresponding scene. Thus, the image retrieval part 130, when signature information corresponding to the capture image exists, extracts play time or frame number for the corresponding signature information to identify the play time of the screen being currently displayed.

In 313, the image retrieval part 130 transmits the identification information and play time information of the media content to the additional content providing part 140.

In 315, the additional content providing part 140 selects additional content information after the reference time on the basis of the identification information of the media content, the play time and the pre-stored additional content information. Here, the reference time may mean any point after the play time which is calculated by considering network delay and execution time, etc. Selecting additional content information after the reference time means selecting additional content information for the scenes displayed after the reference time from a variety of additional content information for the corresponding media content. That is, additional content information before the reference time may not be selected from a variety of additional content information.

In 317, the additional content providing part 140 obtains the signature information corresponding to the selected additional content information from the signature information database 120.

In 319, the additional content providing part 140 transmits the selected additional content information and the obtained signature information to the user device 200.

In 321, the user device 200 provides augmented media services based on the received information. When a user changes play time while watching no real-time video-on-demand (VOD) from the broadcasting/media receiving terminal 300, the user device 200 may proceed to the previous step 309. For example, the user device 200 compares scene information of the media content which is being displayed on the broadcasting/media receiving terminal 300 with signature information of the additional contents to be displayed at the corresponding play time. When the results do not match each other, it proceeds to step 309 and transmits the capture image and the capture time for the media content, which is currently being displayed, to the image retrieval part 130.

FIG. 4A and FIG. 4B illustrate additional content information according to an embodiment of the present invention.

Referring to FIG. 4A, additional content information 410 may comprise at least one selected from additional content 412 to be augmented to media contents, at least one scene image 414 and spatio-temporal information 416.

The additional content 412 may be provided in the form of various images such as icons or in the form of texts (including URL) or audio.

The scene image 414 may comprise at least one scene in which the additional content 412 will be displayed. For example, the scene image 414 may comprise a starting scene, an ending scene and at least one scene locating between the starting scene and the ending scene.

The spatio-temporal information 416 may comprise at least one of time information and space information to be displayed on the user device. Time information to be displayed on the user device, when frames relating to the corresponding additional content 412 are played, may be information about how long the corresponding additional content 412 is displayed. Space information to be displayed on the user device, for example, when frames relating to the corresponding additional content 412 are played, may be information about where the corresponding additional content 412 will be displayed on the display areas of the user device. For example, it may be information about the corresponding additional content 412 to be displayed on the edge of the display or inside the media content. Or it may be information about the additional content 412 to be displayed using overlay technique on the media content.

As shown in FIG. 4B, additional content information may be stored by media content at the additional content providing part 140. Here, the additional content providing part 140, when the identification information of the media content is received from the image retrieval part 130, may extract only additional content information for the media content corresponding to the corresponding identification information.

FIG. 5 illustrates signature information according to an embodiment of the present invention.

A plurality of image frames 510 shown in FIG. 5 are frames corresponding to the additional content information among the image frames of the media content. The image frame may comprise at least one key frame 512a and at least one delta frame (or inter frame) 514a for each key frame. The key frame may be I frame (Intra frame). The delta frame may be one of P frame (Predicted frame) and B frame (Bidirectional frame).

The signature information 520 may comprise at least one of additional content identification information 522, key frame feature point information 524 and static key frame feature point information 526.

The additional content identification information 522 may be ID of an additional content.

The key frame feature point information 524 may be information about feature points extracted from the key frame 512a and conventional various methods may be used for generating feature point information.

The static key frame feature point information 526 may be obtained by analyzing the key frame 512a and the delta frames included in one group of picture (GOP). In an embodiment, the static key frame feature point information 526 may comprise feature point information for the image areas (static areas 514b) of which changes are relatively small within each frame.

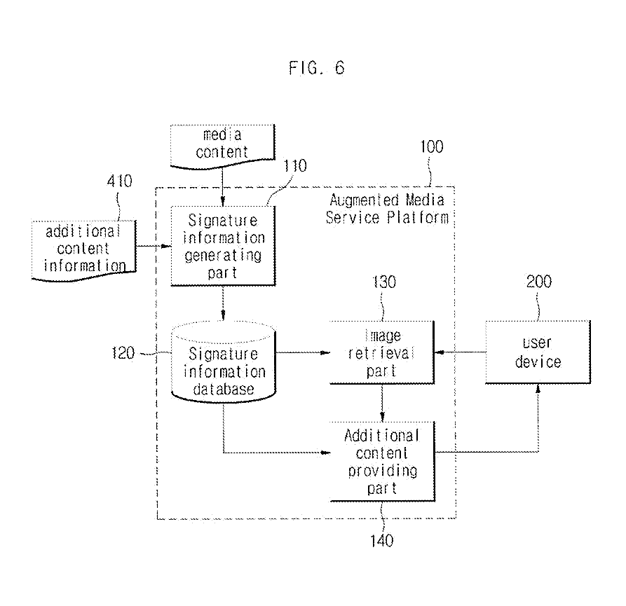

FIG. 6 is a block diagram illustrating an augmented media service providing apparatus according to an embodiment of the present invention.

Referring to FIG. 6, an augmented media service providing apparatus according to an embodiment of the present invention comprises a signature information generating part 110, a signature information database 120, an image retrieval part 130 and an additional content providing part 140.

The signature information generating part 110 receives media contents and additional content information 410 and searches scenes including an additional content from the media content or model information. When the scene including an additional content (or the scene including a particular model) is searched, signature information used for the corresponding scene recognition is generated and stored in the signature information database 120. The signature information may be stored by media content.

The image retrieval part 130 identifies the targeted media content based on the capture image received from the user device 200 and the signature information stored in the signature information database 120. The image retrieval part 130 further transmits identification information of the identified media content to the additional content providing part 140.

The additional content providing part 140 selects the additional content information which is used for augmenting the corresponding media content based on the identification information of the media content received from the image retrieval part 130 and the pre-stored additional content information. The additional content providing part 140 also obtains signature information of the identified media content from the signature information database 120. The additional content providing part 140 transmits the selected additional content information and the obtained signature information to the user device 200.

In an embodiment, the image retrieval part 130 further identifies play time of the targeted media content based on the signature information database 120 and the capture image. The image retrieval part 130 also receives capture time taken for the capture image from the user device 200. Here, the image retrieval part 130 may transmit the identified play time and the received capture time to the additional content providing part 140 and the additional content providing part 140 may calculate reference time based on the received capture time and play time and select additional content information to be used for augmentation after the calculated reference time. The additional content providing part 140 may obtain signature information corresponding to the selected additional content information from the signature information database 120 and transmit the selected additional content information and the obtained signature information to the user device 200.

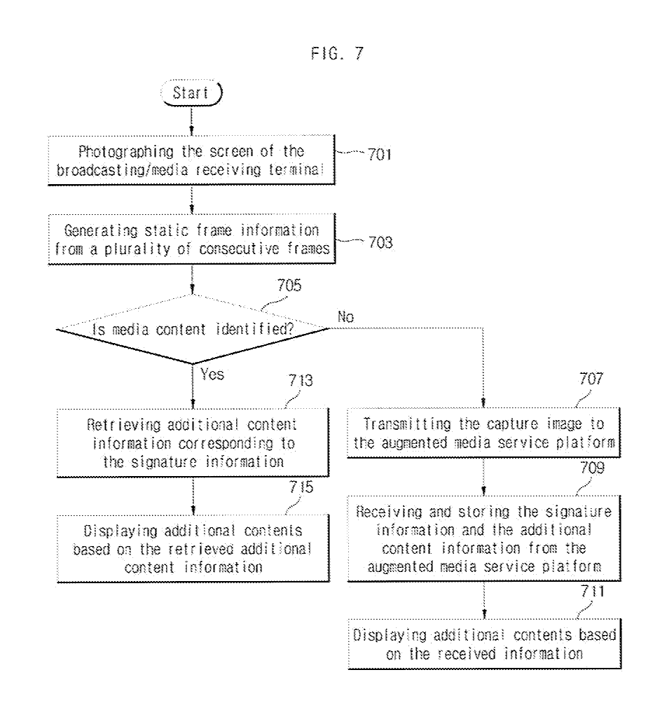

FIG. 7 is a flowchart illustrating an augmented media service providing method from a user device according to an embodiment of the present invention.

In 701, the user device generates at least one capture image from photographing images taken from the screen of the broadcasting/media receiving terminal. The photographing images may be preview images of a preview mode or edited preview images.

In 703, the user device generates static frame information from a plurality of consecutive frames and then proceeds to step 705. For example, the user device can generate static frame information for static areas, in which differences between two or more of consecutive preview images are removed. The static frame information can be generated by using the same method used for generating the above-mentioned key frame feature point information.

In 705, the user device determines if the targeted media content is identified and then proceeds to step 713 when it is identified or proceeds to step 707 when it is not identified. The user device can identify the targeted media content on the basis of the predetermined similarity. In an embodiment, the user device can compare the similarity between static key frame feature point information 526 at around corresponding time and the generated capture image by considering play time from the pre-stored signature information received from the augmented media service platform for identifying the corresponding media content. When similar images are identified, the user device can further compare the similarity between key frame feature point information 524 and the generated capture image to determine an accurate frame. The static frame information generated in Step 703 can be used for the similarity comparison.

In 707 which is performed when the targeted media content is not identified in 705, the user device transmits the generated capture image to the augmented media service platform. According to an embodiment, the user device performs eliminating surrounding areas other than the scene area of the broadcasting/media receiving terminal from the capture image and then transmits the edited image to the augmented media service platform. For example, the capture image may include various background scenes such as surrounding objects, walls and the like in addition to the broadcasting/media receiving terminal. Therefore, it is necessary to extract pure image scene in order to increase a recognition rate. For this purpose, boarders of the broadcasting/media receiving terminal should be identified. Example of an image recognition method may include a rectangular marker recognition method, a four-vertex marker recognition method and a markerless method through leaning boarder lines of a terminal. The user device recognizes the boarder of the broadcasting/media receiving terminal from the capture image and transmits only scene area which is within the boarder lines.

In 709, the user device receives the signature information and the additional content information from the augmented media service platform, stores the received information, and proceeds to Step 711.

In 711, the user device displays additional contents based on the received information which is the signature information and the additional content information.

In 713 which is performed when the targeted media content is identified in 705, the user device retrieves additional content information which corresponds to the signature information for the targeted media content and then displays additional contents based on the retrieved additional content information in 715.

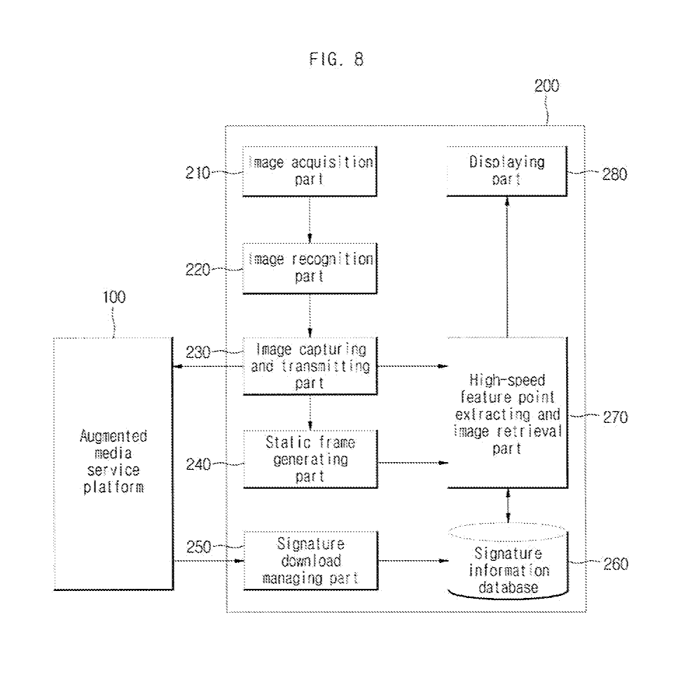

FIG. 8 is a block diagram illustrating an augmented media service providing apparatus from a user device according to an embodiment of the present invention.

Referring to FIG. 8, an augmented media service providing apparatus for a user device according to an embodiment of the present invention comprises an image acquisition part 210, an image recognition part 220, an image capturing and transmitting part 230, a static frame generating part 240, a signature download managing part 250, a signature information database 260, a high-speed feature point extracting and image retrieval part 270 and a displaying part 280. At least one of those components may be omitted.

The image acquisition part 210 photographs an image and transmits it to the image recognition part 220. The image acquisition part 210 may include a camera, generate a preview image of a preview mode, and transmit it to the image recognition part 220.

The image recognition part 220 recognizes the image received from the image acquisition part 210. The image recognition part 220 distinguishes the area where media contents are displayed against the other areas from the received image. The image recognition part 220 transmits information relating to the area where media contents are displayed to the image capturing and transmitting part 230.

The image capturing and transmitting part 230 generates a capture image based on the information received from the image recognition part 220 and transmits the generated capture image to the augmented media service platform 100 or to the high-speed feature point extracting and image retrieval part 270. The image capturing and transmitting part 230 edits by eliminating the surrounding areas other than the area where media contents are displayed on the basis of the information received from the image recognition part 220 and thus generates a capture image only for the area where media contents are displayed.

The static frame generating part 240 analyses the captured image and generates static frame information which is the information for the static area where there are no differences when compared with a plurality of consecutive frames.

The signature download managing part 250 stores the information received from the augmented media service platform 100 to the signature information database 260.

The signature information database 260 stores and manages the information, for example, the signature information and the additional content information, received from the augmented media service platform 100. In an embodiment, the information can be inputted and stored by a user or a system operator. According to an embodiment, the information may be sorted and stored by media content. Thus, when the information is identified, corresponding media content can be identified.

The high-speed feature point extracting and image retrieval part 270 identifies the corresponding media content. For example, the high-speed feature point extracting and image retrieval part 270 can identify the targeted media content by comparing the capture image with the signature information. In an embodiment, the high-speed feature point extracting and image retrieval part 270 first retrieves static key frames which are similar to the captured image by comparing static key frame feature point information from the signature information stored in the signature information database 260 with the captured image and further retrieves lower-level key frames of the retrieved static key frames to identify the corresponding media content. As described above, image frames around an expected play time may be retrieved first. In identifying the targeted media content, the static frame information from the static frame generating part 240 may be used.

The high-speed feature point extracting and image retrieval part 270, when the targeted media content is identified, extracts additional content information and signature information for the corresponding targeted media content from the signature information database 260 and controls to display the additional content on the displaying part 280 on the basis of the extracted information.

The displaying part 280 displays the additional content. The additional content may be displayed with the preview image obtained from the image acquisition part 210 or with the capture image edited at the image capturing and transmitting part 230. The additional content may be displayed on the area which has been eliminated from the edited capture image or be displayed on the basis of the spatio-temporal information included in the additional content information.

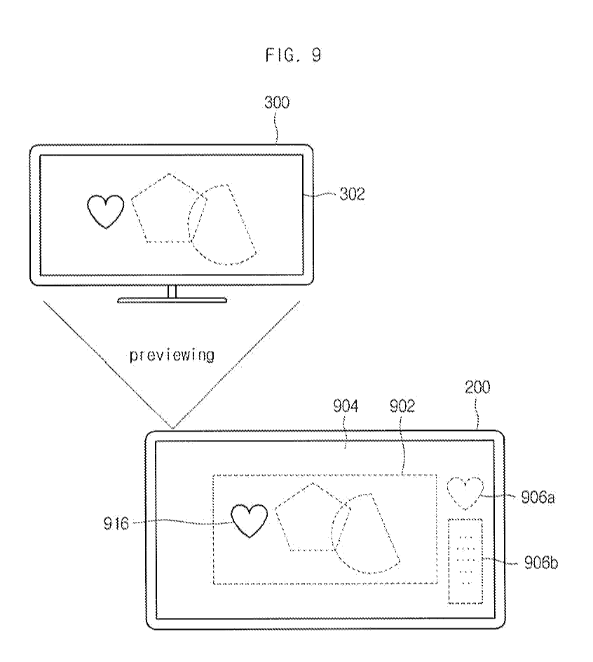

FIG. 9 illustrates an augmented media service providing screen according to an embodiment of the present invention.

Referring to FIG. 9, the user device 200 may display preview images 902 of the broadcasting/media receiving terminal 300 which is displaying media contents. The preview image 902 may target for a playing area 302 of the media content. For example, the preview image 902 may be the image in which the surrounding area 904 of the broadcasting/media receiving terminal 300, which is not the playing area 302 of the media content, is excluded.

The user device 200, when an image or model 916 relating to the additional content is recognized, may display the additional content relating to the corresponding image or model 916 on the basis of the information received from the augmented media service platform or on the basis of the information stored therein. The additional content may be provided in the form of images 906a or texts 906b.

As described above, the additional content information received from the augmented media service platform may include spatio-temporal information of the additional content to be displayed in the user device. The user device may display the additional content on the basis of the information or display the additional content on a display area according to the setting of the user device.

While the present invention has been described with exemplary embodiments in which the augmented media service platform is operated on one apparatus, it is to be appreciated that at least one of the components configuring the augmented media service platform may be operated on a different apparatus. For example, each of the signature information generating part, the signature information database, the image retrieval part and the additional content providing part may be operated on different apparatuses as an independent apparatus.

Exemplary embodiments described above may be implemented by a variety of methods. For example, exemplary embodiments of the present invention may be implemented by using hardware, software or a combination thereof. When it is implemented by software, it may be implemented as software executed on one or more of processors using various operating systems or platforms. Furthermore, the software may be made by using any of a variety of appropriate programing languages or compiled with machine codes or intermediate codes executable in framework or virtual machine.

When exemplary embodiments of the present invention are executed on one or more of processors, it may be implemented by a computer readable media (for example, a memory, a floppy disk, a hard disk, a compact disk, an optical disk, a magnetic tape, or the like) which is recoded with at least one of programs to perform the methods.

What is claimed is:

1. An augmented media service providing apparatus comprising:
an image retrieval part receiving capture images generated by taking the screen of media contents being displayed on a broadcasting/media receiving terminal from a user device, and identifying a targeted media content based on pre-established signature information database for scene recognition and the capture image; and
an additional content providing part selecting at least one additional content information which is used for augmenting the targeted media content from pre-stored additional content information based on identification information of the targeted media content and transmitting the selected additional content information and signature information of the targeted media content to the user device.

2. The augmented media service providing apparatus of claim 1, wherein the image retrieval part further receives capture time of the capture image from the user device and identifies play time of the targeted media content based on the signature information database and the capture image; and the additional content providing part selects an additional content information to be displayed after the reference time calculated based on the capture time and the play time.

3. The augmented media service providing apparatus of claim 1, further comprising a signature information generating part receiving media contents and additional content information which is used for augmenting the corresponding media content, retrieving scenes including additional contents from the media content, generates signature information which is used for the retrieved scene recognition and storing the signature information in the signature information database.

4. The augmented media service providing apparatus of claim 3, wherein the signature information comprises additional content identification information and feature point information of frames of which the additional contents will be augmented.

5. The augmented media service providing apparatus of claim 4, wherein the feature point information comprises:
key frame feature point information for key frames among the image frames of the retrieved scenes; and
static key frame feature point information which is information for static areas identified by analyzing key frames and delta frames included in each Group of Picture (GOP) from the image frames.

6. The augmented media service providing apparatus of claim 1, wherein the additional content information comprises at least one of additional contents to be augmented, at least one scene image relating to the additional contents, and spatio-temporal information for displaying the additional contents in the user device.

7. An augmented media service providing method comprising:
receiving capture images generated by taking the screen of media contents being displayed on a broadcasting/media receiving terminal from a user device;
identifying a targeted media content based on pre-established signature information database for scene recognition and the capture image;
selecting at least one additional content information which is used for augmenting the targeted media content from pre-stored additional content information based on identification information of the targeted media content; and
transmitting the selected additional content information and signature information of the targeted media content to the user device.

8. The augmented media service providing method of claim 7, further comprising:
receiving capture time of the capture image from the user device; and
identifying play time of the targeted media content based on the signature information database and the capture image,
wherein the step of selecting the at least one additional content information comprises selecting additional content information to be displayed after the reference time calculated based on the capture time and the play time.

9. The augmented media service providing method of claim 7, further comprising:
receiving media contents and additional content information which is used for augmenting the corresponding media content;
retrieving scenes including additional contents from the media content; and
generating signature information which is used for the retrieved scene recognition to produce the signature information database.

10. The augmented media service providing method of claim 9, wherein the signature information comprises additional content identification information and feature point information of frames of which the additional contents will be augmented.

11. The augmented media service providing method of claim 10, wherein the feature point information comprises:
key frame feature point information for key frames among the image frames of the retrieved scenes; and
static key frame feature point information which is information for static areas identified by analyzing key frames and delta frames included in each Group of Picture (GOP) from the image frames.

12. The augmented media service providing method of claim 7, wherein the additional content information comprises at least one selected from additional contents to be augmented, at least one scene image relating to the additional contents, and spatio-temporal information for displaying the additional contents in the user device.

13. A augmented media service providing system comprising:
a user device generating capture images by taking screen of media contents being displayed on a broadcasting/media receiving terminal, transmitting the capture images to an augmented media service platform when the targeted media content is not identified, and displaying additional contents based on the information received from the augmented media service platform; and
the augmented media service platform identifying the targeted media content based on pre-established signature information database for scene recognition and the capture image, selecting at least one additional content information, which is used to augment the targeted media content, from pre-stored additional content information based on identification information of the targeted media content, and transmitting the selected additional content information and the signature information of the targeted media content to the user device.

14. The augmented media service providing system of claim 13, wherein the user device identifies the screen area and surrounding area among the capture images, generates capture images in which the surrounding area is excluded, and transmits the result to the augmented media service platform.

15. The augmented media service providing system of claim 14, wherein the user device displays the additional contents on the surrounding area.

16. The augmented media service providing system of claim 13, wherein the user device stores the signature information received from the augmented media service platform and displays additional contents based on the signature information stored by corresponding the targeted media content in the user device and the additional content information when the targeted media content in the taken screen are identified.
